(19) United States
(12) Patent Application Publication
(10) Pub. No.: US 2022/0343056 A1
(43) Pub. Date: Oct. 27, 2022

(54) METHOD FOR LOADING IMAGE AND ELECTRONIC DEVICE

(71) Applicant: BEIJING DAJIA INTERNET INFORMATION TECHNOLOGY CO., LTD., Beijing (CN)

(72) Inventor: Hongshuo CHEN, Beijing (CN)

(21) Appl. No.: 17/862,594

(22) Filed: Jul. 12, 2022

Related U.S. Application Data
(63) Continuation of application No. PCT/CN2021/072110, filed on Jan. 15, 2021.

(30) Foreign Application Priority Data
Jan. 15, 2020 (CN) 202010043718.4

(51) Int. Cl. G06F 40/106; G06F 16/955; G06F 16/957

(52) U.S. Cl. CPC G06F 40/106; G06F 16/9566; G06F 16/9574

(57) ABSTRACT

Provided are a method for loading an image, an electronic device, and a storage medium. The method includes determining, in response to a target image to be loaded by a target browser being detected, an image format of the target image; obtaining, in response to the target browser not supporting the image format, target image data in a predetermined image encoding format, where the target browser supports the predetermined image encoding format; and loading and displaying the target image via the target browser by replacing a Uniform Resource Locator (URL) of the target image with the target image data in the predetermined image encoding format.

### CROSS-REFERENCE TO RELATED APPLICATION

The present disclosure is a continuation application of International Application No. PCT/CN2021/072110 filed on Jan. 15, 2021, which claims priority to Chinese Patent Application No. 202010043718.4 filed on Jan. 15, 2020, the disclosure of which is hereby incorporated by reference in their entireties.

### TECHNICAL FIELD

The present disclosure relates to the field of image processing, and in particular, to a method for loading an image, an electronic device and a storage medium.

### BACKGROUND

WebP is an image file format that provides both lossy and lossless compression (reversible compression). For two images of the same size in WebP format and JPG format, the image in WebP format is clearer than the image in JPG format.

### SUMMARY

The present disclosure provides a method for loading an image, an electronic device and a storage medium. The technical solutions of the present disclosure are as follows.

According to some embodiments of the present disclosure, there is provided a method for loading an image. The method includes: determining, in response to a target image to be loaded by a target browser being detected, an image format of the target image; obtaining, in response to the target browser not supporting the image format, target image data in a predetermined image encoding format, where the target browser supports the predetermined image encoding format; and loading and displaying the target image via the target browser by replacing a Uniform Resource Locator (URL) of the target image with the target image data in the predetermined image encoding format.

According to some embodiments of the present disclosure, there is provided an electronic device. The electronic device includes a processor, and a memory for storing instructions executable for the processor. The processor is configured to determine, in response to a target image to be loaded by a target browser being detected, an image format of the target image; obtain, in response to the target browser not supporting the image format, target image data in a predetermined image encoding format, where the target browser supports the predetermined image encoding format; and load and display the target image via the target browser by replacing a Uniform Resource Locator (URL) of the target image with the target image data in the predetermined image encoding format.

According to some embodiments of the present disclosure, there is provided a non-transitory storage medium that, when instructions in the storage medium are executed by a processor of an electronic device, enables the electronic device to perform the method for loading the image as described above.

### BRIEF DESCRIPTION OF THE DRAWINGS

FIG. 1 is a flowchart of a method for loading an image illustrated in accordance with some embodiments.

FIG. 2 is a flowchart of another method for loading an image illustrated in accordance with some embodiments.

FIG. 3 is a block diagram of an apparatus for loading an image illustrated in accordance with some embodiments.

FIG. 4 is a block diagram of an electronic device illustrated in accordance with some embodiments.

FIG. 5 is a block diagram of a device for loading an image illustrated in accordance with some embodiments.

FIG. 6 is a block diagram of another device for loading an image illustrated in accordance with some embodiments.

### DETAILED DESCRIPTION

In order to enable a person of ordinary skill in the art to better understand the technical solutions of the present disclosure, the technical solutions in the embodiments of the present disclosure will be clearly and completely described below, in conjunction with the accompanying drawings.

WebP is an image file format that provides both lossy and lossless compression (reversible compression). For two images of the same size in WebP format and JPG format, the image in WebP format is clearer than the image in JPG format.

However, in the related art, some browsers such as Internet Explorer do not support the images in WebP format, so browsers that do not support the images in WebP format cannot successfully load the images in WebP format.

In order to solve the problem in related art that a browser cannot successfully load an image in WebP format due to the browser not supporting the image in WebP format, the present disclosure provides a method for loading an image, an electronic device, and a storage medium.

The method for loading the image provided by the embodiments of the present disclosure is first described in detail.

It should be noted that the method for loading the image provided by the embodiments of the present disclosure may be performed by an electronic device or may be performed by an apparatus for loading the image which runs in the electronic device. The electronic device can be a terminal or a server, which is not specifically limited by the embodiments of the present disclosure.

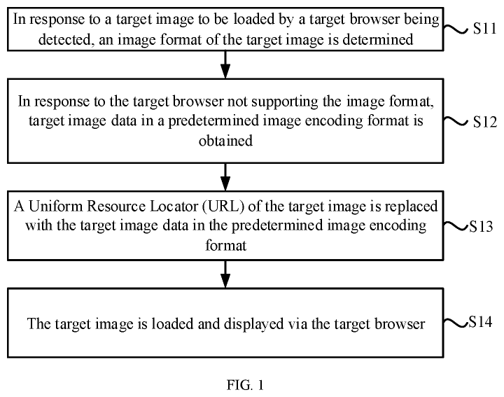

FIG. 1 is a flowchart of a method for loading an image illustrated in accordance with some embodiments. The method, as shown in FIG. 1, may include the following steps S11, S12, S13, and S14.

In step S11, in response to a target image to be loaded by a target browser being detected, an image format of the target image is determined.

The target browser may be any browser of the electronic device as the executing subject. The target image may be any image to be loaded by the target browser, which may be Cascading Style Sheets (CSSs).

In some embodiments, when a user wants to access a web page through a target browser, the user may send a web page access command to the electronic device as the executing subject, and at this time, the electronic device as the executing subject may receive the web page access command. Moreover, the electronic device as the executing subject may detect whether the web page to be accessed includes an image, and when it detects that the web page to be accessed includes an image, that is, when it detects that the target browser needs to load a target image, the target image is any one of images included in the web page to be accessed. And then, the electronic device as the executing subject may determine the image format of the target image.

The image format of the target image may be any one of: JPG format, GIF format, BMP format, TIF format, WebP format, etc. It should be understood that the image format of the target image may be determined according to the actual situation, which is not specifically limited by the embodiments of the present disclosure.

In step S12, in response to the target browser not supporting the image format, target image data in a predetermined image encoding format is obtained.

The target browser supports the predetermined image encoding format.

In order to avoid that the target browser cannot load the target image successfully in the subsequent steps because the target browser does not support the image format of the target image, the electronic device as the executing subject, after determining the image format of the target image, may determine whether the target browser supports the image format of the target image.

For example, it is assumed that the image format of the target image is WebP format and the target browser is Internet Explorer, since Internet Explorer does not support WebP format, the electronic device may determine that the target browser does not support the image format of the target image.

For another example, it is assumed that the image format of the target image is WebP format and the target browser is Firefox, since Firefox supports WebP format, the electronic device may determine that the target browser supports the image format of the target image.

If the electronic device as the executing subject determines that the target browser does not support the image format of the target image, it may obtain target image data in a predetermined image encoding format, and the predetermined image encoding format is supported by the target browser, so that the target image can be loaded successfully in the subsequent steps.

In some embodiments, the image format of the target image is WebP format, and the predetermined image encoding format is Base64. Base64 is an image encoding format that involves a method of representing binary data based on 64 printable characters. In some embodiments, the predetermined image encoding format may be any image encoding format supported by the target browser, and the embodiments of the present disclosure do not specifically limit the image encoding format.

In addition, there can be various ways to obtain the target image data in the predetermined image encoding format.

In some embodiments, the electronic device as the executing subject can start an asynchronous thread, and through the asynchronous thread the target image is converted into the target image data in the predetermined image encoding format using a predetermined WebPJS library. Since the process of converting the target image into the target image data in the predetermined image encoding format is performed in the target asynchronous thread, no thread blocking will be caused, thus improving the performance of the electronic device as the executing subject.

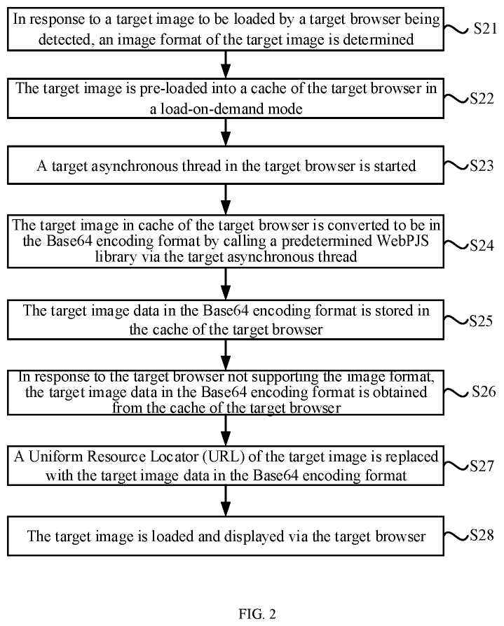

In some other embodiments, the electronic device as the executing subject may obtain the target image data in the predetermined image encoding format directly from the browser cache, which will be elaborated in the embodiments of FIG. 2 in order to describe the scheme clearly.

In step S13, a Uniform Resource Locator (URL) of the target image is replaced with the target image data in the predetermined image encoding format.

After the electronic device as the executing subject obtains the target image data in the predetermined image encoding format, the URL of the target image may be replaced with the target image data in the predetermined image encoding format when loading the target image.

In some embodiments, when the predetermined image encoding format is Base64, the URL of the target image may be replaced with the target image data in the Base64 encoding format, which helps the target browser to load the target image successfully in the subsequent steps.

In step S14, the target image is loaded and displayed via the target browser.

After replacing the URL of the target image with the target image data in the predetermined image encoding format, since the target browser supports the predetermined image encoding format, the target image can be loaded and displayed via the target browser. In this way, browsers that originally did not support images in WebP format can successfully load the target image and thus can display images in WebP format normally.

In the technical solutions provided by the embodiments of the present disclosure, in response to the target image to be loaded by the target browser being detected, the image format of the target image is determined; in response to the target browser not supporting the image format, the target image data in the predetermined image encoding format is obtained, where the target browser supports the predetermined image encoding format; the URL of the target image is replaced with the target image data in the predetermined image encoding format; and the target image is loaded and displayed via the target browser.

It can be seen that in the technical solutions provided by the embodiments of the present disclosure, when it is determined that the target browser does not support the image format of the target image, the URL of the target image can be replaced with the target image data in the predetermined image encoding format. Since the target browser supports the predetermined image encoding format, the target image can be loaded by the target browser and then be displayed. In this way, browsers that originally did not support images in WebP format can be compatible with the images in WebP format, i.e., the target image can be successfully loaded and the images in WebP format can be displayed normally.

FIG. 2 is a flowchart of a method for loading an image illustrated in accordance with an exemplary embodiment. As shown in FIG. 2, the method may include the following steps S21, S22, S23, S24, S25, S26, S27, and S28.

In step S21, in response to a target image to be loaded by a target browser being detected, an image format of the target image is determined.

The target browser may be any browser of the electronic device as the executing subject. The target image may be any image to be loaded by the target browser.

In some embodiments, when a user wants to access a web page through a target browser, the user may send a web page access command to the electronic device as the executing subject, and at this time, the electronic device as the executing subject may receive the web page access command. Moreover, the electronic device as the executing subject may detect whether the web page to be accessed includes an image, and when it detects that the web page to be accessed includes an image, that is, when it detects that the target browser needs to load a target image, the target image is any one of images included in the web page to be accessed. And then, the electronic device as the executing subject may determine the image format of the target image.

The image format of the target image may be any one of: JPG format, GIF format, BMP format, TIF format, WebP format, etc. It should be understood that the image format of the target image may be determined according to the actual situation, which is not specifically limited by the embodiments of the present disclosure.

In step S22, the target image is pre-loaded into a cache of the target browser in a load-on-demand mode.

It should be understood that, Load on Demand is a unique and powerful data acquisition method that automatically acquires more data when the user scrolls the page, while the newly obtained data does not affect the display of the original data, which minimizes the consumption of resources on the server side.

Therefore, the electronic device as the executing subject may pre-load the target image into the cache of the target browser in the load-on-demand mode.

In step S23, a target asynchronous thread in the target browser is started.

In some embodiments, after pre-loading the target image into the cache of the target browser, the electronic device as the executing subject may start the target asynchronous thread of the target browser to convert the target image to be in the Base64 encoding format in the target asynchronous thread in the subsequent steps.

In step S24, the target image in cache of the target browser is converted to be in the Base64 encoding format by calling a predetermined WebPJS library via the target asynchronous thread.

After the target asynchronous thread is started by the electronic device that is the subject of execution, the target image cached in the target browser may be converted to be in the Base64 encoding format by calling the predetermined WebPJS library. Since the process of converting the target image cached in the target browser to be in the Base64 encoding format is performed in the target asynchronous thread, no thread blocking will be caused, thus improving the performance of the electronic device as the executing subject.

In step S25, the target image data in the Base64 encoding format is stored in the cache of the target browser.

After the electronic device as the executing subject converts the target image to be in the Base64 encoding format, it may store the target image data in the Base64 encoding format in the cache of the target browser, so that in the subsequent steps, when the electronic device as the executing subject determines that the target browser does not support the image format, it can obtain the target image data in the Base64 encoding format directly from the cache of the target browser, thereby improving the efficiency of obtaining the target image data in the Base64 encoding format.

In step S26, in response to the target browser not supporting the image format, the target image data in the Base64 encoding format is obtained from the cache of the target browser.

Since the target image data in the Base64 encoding format is stored in the cache of the target browser, the electronic device, which is the execution subject, can directly obtain the target image data in the Base64 encoding format from the cache of the target browser when it determines that the target browser does not support the image format of the target image, improving the efficiency of obtaining the target image data in the Base64 encoding format.

In step S27, a Uniform Resource Locator (URL) of the target image is replaced with the target image data in the Base64 encoding format.

After the electronic device as the executing subject obtains the target image data in the Base64 encoding format, it can replace the URL of the target image with the target image data in the Base64 encoding format when loading the target image. In this way, the target browser can successfully load the target image in the subsequent steps.

In step S28, the target image is loaded and displayed via the target browser.

Since the target browser supports the Base64 encoding format, after replacing the URL of the target image with the target image data in the Base64 encoding format, the target image can be loaded and displayed via the target browser. In this way, browsers that originally did not support images in WebP format can successfully load the target image and thus the images in WebP format can be displayed normally.

It can be seen that in the technical solutions provided by the embodiments of the present disclosure, when it is determined that the target browser does not support the image format of the target image, the target image data in the Base64 encoding format can be obtained directly from the cache of the target browser, and the URL of the target image can be replaced with the target image data in the Base64 encoding format. Since the target browser supports the Base64 encoding format, the target image can be loaded by the target browser and then be displayed. In this way, browsers that originally did not support images in WebP format can be compatible with the images in WebP format, i.e., the target image can be successfully loaded and the images in WebP format can be displayed normally.

On the basis of the embodiment shown in FIG. 2, in some embodiments, after loading and displaying the target image via the target browser, the method for loading the image may further include: deleting the target image and the target image data in the Base64 encoding format from the cache of the target browser.

In this embodiment, after the electronic device as the executing subject loads the target image and displays the image via the target browser, it indicates that the target browser has successfully loaded the target image, at which time the cached target image and the target image data in the Base64 encoding format in the target browser can be deleted to achieve the effect of saving the cache of the target browser.

It can be seen that, in the technical solutions provided by the embodiments of the present disclosure, after loading and displaying the target image through the target browser, the cached target image and the target image data in the Base64 encoding format are deleted from the target browser, thereby achieving the effect of saving the cache of the target browser.

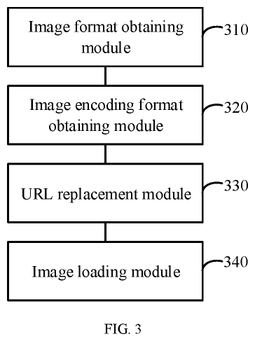

According some embodiments of the present disclosure, there is provided an apparatus for loading an image. As shown in FIG. 3, the apparatus includes: an image format obtaining module 310 configured to determine, in response to a target image to be loaded by a target browser being detected, an image format of the target image; and an image encoding format obtaining module 320 configured to obtain, in response to the target browser not supporting the image format, target image data in a predetermined image encoding format, where the target browser supports the image encoding format of the predetermined type.

In some embodiments, the image format of the target image is a WebP format and the predetermined image encoding format is Base64.

A URL replacement module 330 is configured to replace a Uniform Resource Locator (URL) of the target image with the target image data in the predetermined image encoding format.

An image loading module 340 is configured to load and display the target image via the target browser.

In the technical solutions provided by the embodiments of the present disclosure, in response to the target image to be loaded by the target browser being detected, the image format of the target image is obtained; in response to the target browser not supporting the image format, the target image data in the predetermined image encoding format is obtained, where the target browser supports the predetermined image encoding format; the URL of the target image is replaced with the target image data in the predetermined image encoding format; and the target image is loaded and displayed via the target browser.

It can be seen that in the technical solutions provided by the embodiments of the present disclosure, when it is detected that the target browser does not support the image format of the target image, the URL of the target image can be replaced with the target image data in the predetermined image encoding format. Since the target browser supports the predetermined image encoding format, the target image can be loaded by the target browser and then be displayed. In this way, browsers that originally did not support images in WebP format can be compatible with the images in WebP format, i.e., the target image can be successfully loaded and the images in WebP format can be displayed normally.

In some embodiments, the apparatus further includes: an image pre-loading module configured to pre-load the target image into a cache of the target browser in a load-on-demand mode; a thread start module configured to start a target asynchronous thread in the target browser; an image conversion module configured to convert the target image in the cache of the target browser to be in the Base64 encoding format by calling a predetermined WebPJS library via the target asynchronous thread; and a Base64 storage module configured to store the target image data in the Base64 encoding format to the cache of the target browser.

It can be seen that in the technical solutions provided by the embodiments of the present disclosure, when it is determined that the target browser does not support the image format of the target image, the target image data in the Base64 encoding format can be obtained directly from the cache of the target browser, and the URL of the target image can be replaced with the target image data in the Base64 encoding format. Since the target browser supports the Base64 encoding format, the target image can be loaded by the target browser and then be displayed. In this way, browsers that originally did not support images in WebP format can be compatible with the images in WebP format, i.e., the target image can be successfully loaded and the images in WebP format can be displayed normally.

In some embodiments, the image encoding format obtaining module is configured to obtain the target image data in the Base64 encoding format from the cache of the target browser.

In some embodiments, the apparatus further includes a delete module configured to delete the target image and the target image data in the Base64 encoding format from the cache of the target browser.

It can be seen that, in the technical solutions provided by the embodiments of the present disclosure, after loading and displaying the target image through the target browser, the cached target image and the target image data in the Base64 encoding format are deleted from the target browser, thereby achieving the effect of saving the cache of the target browser.

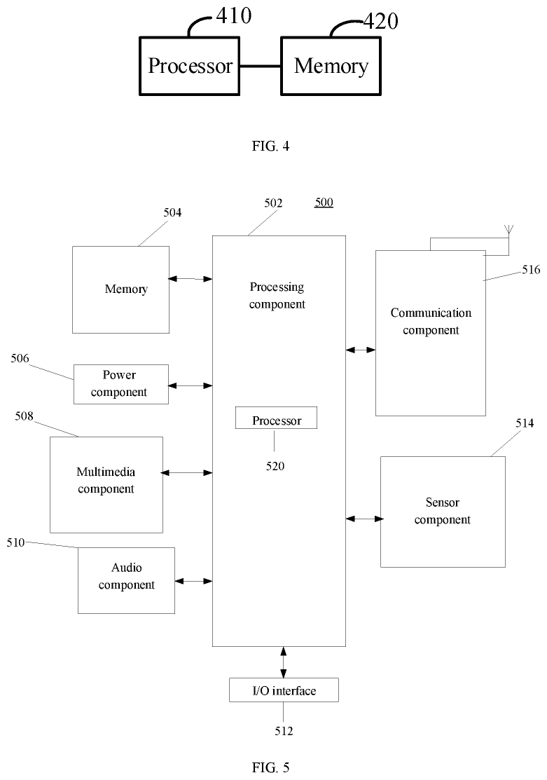

According to some embodiments of the present disclosure, there is provided an electronic device. FIG. 4 is a block diagram of an electronic device illustrated in accordance with an exemplary embodiment. Referring to FIG. 4, the electronic device includes a processor 410, and a memory 420 for storing instructions executable for the processor. The processor is configured to execute the instructions to implement the method for loading the image provided by the present disclosure.

In the technical solutions provided by the embodiments of the present disclosure, in response to the target image to be loaded by the target browser being detected, the image format of the target image is determined; in response to the target browser not supporting the image format, the target image data in the predetermined image encoding format is obtained, where the target browser supports the predetermined image encoding format; the URL of the target image is replaced with the target image data in the predetermined image encoding format; and the target image is loaded and displayed via the target browser.

It can be seen that in the technical solutions provided by the embodiments of the present disclosure, when it is determined that the target browser does not support the image format of the target image, the URL of the target image can be replaced with the target image data in the predetermined image encoding format. Since the target browser supports the predetermined image encoding format, the target image can be loaded by the target browser and then be displayed. In this way, browsers that originally did not support images in WebP format can be compatible with the images in WebP format, i.e., the target image can be successfully loaded and the images in WebP format can be displayed normally.

FIG. 5 is a block diagram of a device 500 for loading an image illustrated in accordance with an exemplary embodiment. For example, the device 500 may be a mobile phone, a computer, a digital broadcast terminal, a messaging device, a game console, a tablet device, a medical device, a fitness device, a personal digital assistant, and the like.

Referring to FIG. 5, the device 500 may include one or more of the following components: a processing component 502, a memory 504, a power component 506, a multimedia component 508, an audio component 510, an input/output (I/O) interface 512, a sensor component 514, and a communication component 516.

The processing component 502 is generally configured to control the overall operation of the device 500, such as operations associated with displaying, telephone calling, data communications, camera operations, and recording operations. The processing component 502 may include one or more processors 520 for executing instructions to complete all or part of the steps of the method for loading the image described above. In addition, the processing component 502 may include one or more modules to facilitate the interaction between the processing component 502 and other components. For example, the processing component 502 may include a multimedia module to facilitate the interaction between the multimedia component 508 and the processing component 502.

The memory 504 is configured to store various types of data to support operations on the device 500. Examples of such data include instructions for any application or method operating on the device 500, contact data, phone book data, messages, pictures, videos, and the like. The memory 504 may be implemented by any type of volatile or non-volatile storage devices or a combination thereof, such as Static Random Access Memory (SRAM), Electrically Erasable Programmable Read-only Memory (EEPROM), Erasable Programmable Read-only Memory (EPROM), Programmable Read Only Memory (PROM), Read-only Memory (ROM), magnetic memory, flash memory, magnetic or optical disk.

The power component 506 is configured to provide power for various components of the device 500. The power component 506 may include a power management system, one or more power supplies, and other components associated with generating, managing, and distributing power for the device 500.

The multimedia component 508 includes a screen that provides an output interface between the device 500 and the user. In some embodiments of the present disclosure, the screen may include a Liquid Crystal Display (LCD) and a Touch Panel (TP). If the screen includes a touch panel, the screen may be implemented as a touch screen to receive input signals from the user. The Touch Panel includes one or more touch sensors to sense touch, slide, and gestures on the Touch Panel. The touch sensor may not only sense the boundary of the touch or slide action, but also detect the duration and pressure associated with the touch or slide operation. In some embodiments of the present disclosure, the multimedia component 508 includes a front camera and/or a rear camera. When the device 500 is in an operation mode, such as a shooting mode or a video mode, the front camera and/or the rear camera may receive external multimedia data. Each front camera and rear camera may be a fixed optical lens system or have a focal length and optical zoom capability.

The audio component 510 is configured to output and/or input audio signals. For example, the audio component 510 includes a microphone (MIC), and when the device 500 is in an operation mode, such as a call mode, a recording mode, and a voice recognition mode, the microphone is configured to receive external audio signals. The received audio signal may be further stored in the memory 504 or transmitted via the communication component 516. In some embodiments, the audio component 510 further includes a speaker for outputting audio signals.

The I/O interface 512 provides an interface between the processing component 502 and a peripheral interface module. The above-described peripheral interface module may be a keyboard, a click wheel, a button, and the like. These buttons may include, but are not limited to: a home button, a volume button, a start button, and a lock button.

The sensor component 514 includes one or more sensors for providing the device 500 with various aspects of status assessment. For example, the sensor component 514 may detect the open/close status of the device 500 and the relative positioning of components, such as a display and keypad of the device 500. The sensor component 514 may also detect the position change of the device 500 or a component of the device 500, the presence or absence of contact between the user and the device 500, the orientation or acceleration/deceleration of the device 500, and the temperature change of the device 500. The sensor component 514 may include a proximity sensor configured to detect the presence of a nearby object without any physical contact. The sensor component 514 may further include an optical sensor, such as a CMOS or CCD image sensor, for use in imaging applications. In some embodiments, the sensor component 514 may further include an acceleration sensor, a gyroscope sensor, a magnetic sensor, a pressure sensor, or a temperature sensor.

The communication component 516 is configured to facilitate wired or wireless communication between the device 500 and other devices. The device 500 can access a wireless network based on a communication standard, such as WiFi, an operator network (such as 2G, 3G, 4G, or 5G), or a combination thereof. In an exemplary embodiment, the communication component 516 receives a broadcast signal or broadcast related information from an external broadcast management system via a broadcast channel. In an exemplary embodiment, the communication component 516 further includes a Near Field Communication (NFC) module to facilitate short-range communication. For example, the NFC module may be implemented based on Radio Frequency Identification (RFID) technology, Infrared Data Association (IrDA) technology, Ultra-wideband (UWB) technology, Bluetooth (BT) technology and other technologies.

In exemplary embodiments, the device 500 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controller, microcontroller, microprocessor, or other electronic components for performing the above-described method.

In exemplary embodiments, there is further provided a non-transitory computer-readable storage medium including instructions, such as the memory 504 including instructions which may be executed by the processor 520 of the device 500 to complete the above-described method. Optionally, the storage medium may be the non-transitory computer-readable storage medium, for example, the non-transitory computer-readable storage medium may be a ROM, a Random Access Memory (RAM), a CD-ROM, a magnetic tape, a floppy disk, an optical data storage device, etc.

In the technical solutions provided by the embodiments of the present disclosure, in response to the target image to be loaded by the target browser being detected, the image format of the target image is obtained; in response to the target browser not supporting the image format, the target image data in the predetermined image encoding format is obtained, where the target browser supports the predetermined image encoding format; the URL of the target image is replaced with the target image data in the predetermined image encoding format; and the target image is loaded and displayed via the target browser.

It can be seen that in the technical solutions provided by the embodiments of the present disclosure, when it is determined that the target browser does not support the image format of the target image, the URL of the target image can be replaced with the target image data in the predetermined image encoding format. Since the target browser supports the predetermined image encoding format, the target image can be loaded by the target browser and then be displayed. In this way, browsers that originally did not support images in WebP format can be compatible with the images in WebP format, i.e., the target image can be successfully loaded and the images in WebP format can be displayed normally.

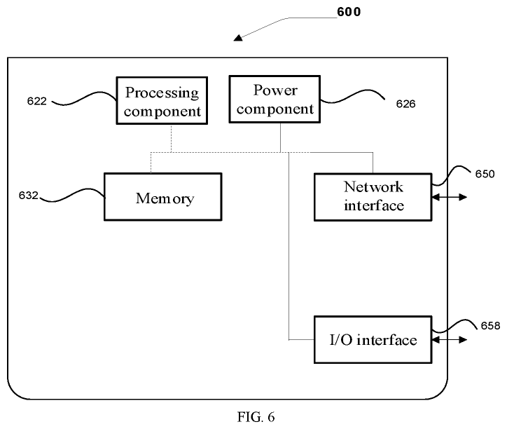

FIG. 6 is a block diagram of a device 600 for loading an image illustrated in accordance with an exemplary embodiment. For example, the device 600 may be provided as a server. Referring to FIG. 6, the device 600 includes a processing component 622, which further includes one or more processors, and a memory resource represented by the memory 632, for storing instructions that may be executed by the processing component 622, such as an application. The application stored in the memory 632 may include one or more modules that each corresponds to a set of instructions. In addition, the processing component 622 is configured to execute instructions to perform the method for loading the image described above.

The device 600 may further include a power component 626 configured to perform power management of the device 600, a wired or wireless network interface 650 configured to connect the device 600 to a network, and an input/output (I/O) interface 658. The device 600 may operate based on an operating system stored in the memory 632, such as Windows Server™, Mac OS X™, Unix™, Linux™, FreeBSD™, etc.

In the technical solutions provided by the embodiments of the present disclosure, in response to the target image to be loaded by the target browser being detected, the image format of the target image is obtained; in response to the target browser not supporting the image format, the target image data in the predetermined image encoding format is obtained, where the target browser supports the predetermined image encoding format; the URL of the target image is replaced with the target image data in the predetermined image encoding format; and the target image is loaded and displayed via the target browser.

It can be seen that in the technical solutions provided by the embodiments of the present disclosure, when it is determined that the target browser does not support the image format of the target image, the URL of the target image can be replaced with the target image data in the predetermined image encoding format. Since the target browser supports the predetermined image encoding format, the target image can be loaded by the target browser and then be displayed. In this way, browsers that originally did not support images in WebP format can be compatible with the images in WebP format, i.e., the target image can be successfully loaded and the images in WebP format can be displayed normally.

The present disclosure further provides a non-transitory storage medium that, when instructions in the storage medium are executed by a processor of an electronic device, enables the electronic device to perform the method for loading the image provided by the embodiments of the present disclosure.

In the technical solutions provided by the embodiments of the present disclosure, in response to the target image to be loaded by the target browser being detected, the image format of the target image is obtained; in response to the target browser not supporting the image format, the target image data in the predetermined image encoding format is obtained, where the target browser supports the predetermined image encoding format; the URL of the target image is replaced with the target image data in the predetermined image encoding format; and the target image is loaded and displayed via the target browser.

It can be seen that in the technical solutions provided by the embodiments of the present disclosure, when it is determined that the target browser does not support the image format of the target image, the URL of the target image can be replaced with the target image data in the predetermined image encoding format. Since the target browser supports the predetermined image encoding format, the target image can be loaded by the target browser and then be displayed. In this way, browsers that originally did not support images in WebP format can be compatible with the images in WebP format, i.e., the target image can be successfully loaded and the images in WebP format can be displayed normally.

According to some embodiments of the present disclosure, there is provided a computer program product including instructions which, when run on a computer, causes the computer to implement the method for loading an image as described above.

In the technical solutions provided by the embodiments of the present disclosure, in response to the target image to be loaded by the target browser being detected, the image format of the target image is obtained; in response to the target browser not supporting the image format, the target image data in the predetermined image encoding format is obtained, where the target browser supports the predetermined image encoding format; the URL of the target image is replaced with the target image data in the predetermined image encoding format; and the target image is loaded and displayed via the target browser.

It can be seen that in the technical solutions provided by the embodiments of the present disclosure, when it is determined that the target browser does not support the image format of the target image, the URL of the target image can be replaced with the target image data in the predetermined image encoding format. Since the target browser supports the predetermined image encoding format, the target image can be loaded by the target browser and then be displayed. In this way, browsers that originally did not support images in WebP format can be compatible with the images in WebP format, i.e., the target image can be successfully loaded and the images in WebP format can be displayed normally.

It should be understood that all embodiments of the present disclosure may be performed alone or in combination with other embodiments, and are within the scope of protection claimed by the present disclosure. References in this disclosure to “an embodiment” or “some embodiments” mean that a particular feature, structure, or characteristic associated with an embodiment is included in at least one embodiment of the present disclosure. Thus, “in an embodiment” or “in some embodiments” appearing throughout the specification does not necessarily mean the same embodiment. In addition, these particular features, structures, or characteristics may be combined in any suitable manner in one or more embodiments. It should be understood that in the various embodiments of the present disclosure, the size of the serial numbers of the above processes does not imply the order of execution, and the order of execution of each process should be determined by its function and internal logic, and should not constitute any limitation on the implementation of the processes of the embodiments of the present disclosure. The above serial numbers of the embodiments of the present disclosure are for descriptive purposes only and do not represent the merits of the embodiments.

What is claimed is:

1. A method for loading an image, comprising:
determining, in response to a target image to be loaded by a target browser being detected, an image format of the target image;
obtaining, in response to the target browser not supporting the image format, target image data in a predetermined image encoding format, wherein the target browser supports the predetermined image encoding format; and
loading and displaying the target image via the target browser by replacing a Uniform Resource Locator (URL) of the target image with the target image data in the predetermined image encoding format.

2. The method of claim 1, wherein the image format of the target image is a WebP format and the predetermined image encoding format is Base64.

3. The method of claim 2, further comprising:
pre-loading the target image into a cache of the target browser in a load-on-demand mode;
starting a target asynchronous thread in the target browser;
converting the target image in the cache of the target browser to be in the Base64 encoding format by calling a predetermined WebPJS library via the target asynchronous thread; and
storing the target image data in the Base64 encoding format to the cache of the target browser.

4. The method of claim 3, wherein said obtaining target image data in a predetermined image encoding format comprises:
obtaining the target image data in the Base64 encoding format from the cache of the target browser.

5. The method of claim 3, further comprising:
deleting the target image and the target image data in the Base64 encoding format from the cache of the target browser.

6. An electronic device, comprising:
a processor; and
a memory for storing instructions executable for the processor; wherein
the processor is configured to execute the instructions to perform following acts:
determining, in response to a target image to be loaded by a target browser being detected, an image format of the target image;
obtaining, in response to the target browser not supporting the image format, target image data in a predetermined image encoding format, wherein the target browser supports the predetermined image encoding format; and
loading and displaying the target image via the target browser by replacing a Uniform Resource Locator (URL) of the target image with the target image data in the predetermined image encoding format.

7. The electronic device of claim 6, wherein the image format of the target image is a WebP format and the predetermined image encoding format is Base64.

8. The electronic device of claim 7, wherein the processor is further configured to:
pre-load the target image into a cache of the target browser in a load-on-demand mode;
start a target asynchronous thread in the target browser;
converting the target image in the cache of the target browser to be in the Base64 encoding format by calling a predetermined WebPJS library via the target asynchronous thread; and
store the target image data in the Base64 encoding format to the cache of the target browser.

9. The electronic device of claim 8, wherein the processor is configured to obtain target image data in a predetermined image encoding format by:
obtaining the target image data in the Base64 encoding format from the cache of the target browser.

10. The electronic device of claim 8, wherein the processor is further configured to:
deleting the target image and the target image data in the Base64 encoding format from the cache of the target browser.

11. A non-transitory storage medium, wherein
when instructions in the storage medium are executed by a processor of an electronic device, the storage medium enables the electronic device to perform following acts:
determining, in response to determining a target image to be loaded by a target browser, an image format of the target image;
obtaining, in response to determining that the target browser does not support the image format, target image data in a predetermined image encoding format, wherein the target browser supports the predetermined image encoding format; and
loading and displaying the target image via the target browser by replacing a Uniform Resource Locator (URL) of the target image with the target image data in the predetermined image encoding format.

12. The storage medium of claim 11, wherein the image format of the target image is a WebP format and the predetermined image encoding format is Base64.

13. The storage medium of claim 12, wherein when the instructions in the storage medium are executed by the processor of the electronic device, the storage medium further enables the electronic device to:
pre-load the target image into a cache of the target browser in a load-on-demand mode;
start a target asynchronous thread in the target browser;
convert the target image in the cache of the target browser to be in the Base64 encoding format by calling a predetermined WebPJS library via the target asynchronous thread; and
store the target image data in the Base64 encoding format to the cache of the target browser.

14. The storage medium of claim 13, wherein when the instructions in the storage medium are executed by the processor of the electronic device, the storage medium enables the electronic device to obtain target image data in a predetermined image encoding format by:
obtaining the target image data in the Base64 encoding format from the cache of the target browser.

15. The storage medium of claim 13, wherein when the instructions in the storage medium are executed by the processor of the electronic device, the storage medium further enables the electronic device to:
delete the target image and the target image data in the Base64 encoding format from the cache of the target browser.
